(19) United States
(12) Patent Application Publication
(10) Pub. No.: US 2012/0255173 A1
(43) Pub. Date: Oct. 11, 2012

(54) METHOD FOR RETROFITTING A FOSSIL-FUELED POWER STATION WITH A CARBON DIOXIDE SEPARATION DEVICE

(76) Inventors: Ulrich Grumann, Erlangen (DE); Ulrich Much, Erlangen (DE); Andreas Pickard, Adelsdorf (DE); Mike Rost, Erlangen (DE)

(21) Appl. No.: 13/503,922

(22) PCT Filed: Nov. 2, 2010
(86) PCT No.: PCT/EP2010/066617

§ 371 Date: Jun. 28, 2012

(30) Foreign Application Priority Data
Nov. 2, 2009 (DE) 10 2009 051 607.7

(51) Int. Cl. B23P 6/00

(52) U.S. Cl. 29/888.021

(57) ABSTRACT

A method for retrofitting a fossil-fueled power station having a multiple-casing steam turbine with a carbon dioxide separation device is provided. The maximum flow rate of the steam turbine is adjusted to the process steam that is to be removed for the operation of the carbon dioxide separation device and the carbon dioxide separation device is connected via a steam line to an overflow line that connects two steam turbine casings.

### CROSS REFERENCE TO RELATED APPLICATIONS

This application is the US National Stage of International Application No. PCT/EP2010/066617, filed Nov. 2, 2010 and claims the benefit thereof. The International Application claims the benefits of German application No. 10 2009 051607.7 DE filed Nov. 2, 2009. All of the applications are incorporated by reference herein in their entirety.

### FIELD OF INVENTION

The invention relates to a method for retrofitting a fossil-fueled power station having a multiple-casing steam turbine with a carbon dioxide separation device, in which the maximum flow rate of the steam turbine is adjusted to the process steam that is to be removed for the operation of the carbon dioxide separation device and the carbon dioxide separation device is connected via a steam line to an overflow line that connects two steam turbine casings.

### BACKGROUND OF INVENTION

In order to separate carbon dioxide from exhaust gases of fossil-fueled power stations, like for instance gas and steam power stations or coal-fired steam power stations, a large quantity of energy is needed.

With the use of a wet chemical absorption-desorption method for separating carbon dioxide, this energy must be applied in the form of thermal energy in order to heat the desorption process. To this end low pressure steam from the water/steam cycle of the power station is usually used.

Even if a power station under construction is still not equipped with a carbon dioxide separation device (CO2 capture plant) connected thereto, there is also already the obligation to provide proof of the ability to retrofit (capture readiness). Accordingly, corresponding precautions are already taken nowadays so that a carbon dioxide separation device can be easily integrated into the power station at a subsequent point in time.

In addition, there is the need for the steam turbine and/or the power station process to have to be configured accordingly for the removal of low pressure steam. With steam turbines having a separated housing for the mean and low pressure stage, the removal of low pressure steam on the overflow line is easily possible. Nevertheless, the removal solution on the overflow line results in the lower pressure stage of the steam turbine having to be operated at half throttle during the removal process, since the maximum flow rate of the low pressure stage is dimensioned for operation without low pressure steam removal. Without throttling and upon removal of low pressure steam, this would result in a large drop in pressure in the low pressure part. The throttling of the machine also represents a suboptimal solution in terms of thermodynamics

The removal of steam from other sources within the power station process is also not recommended, or possible in a suitable fashion. A removal from an intermediate overheating line of the steam turbine therefore results for instance in an asymmetric load of the boiler. The removal of high-quality steam for the carbon dioxide separation device must also be ruled out, since this results in unjustifiable energy losses.

### SUMMARY OF INVENTION

The object of the invention is therefore to specify a cost-effective method for retrofitting a carbon dioxide separation device, by means of which an exchange of the lower pressure stage of the steam turbine is avoided, and the removal of low pressure steam from the overflow line is enabled without this resulting in a drop in pressure in the low pressure state.

The object of the invention is achieved by the features of the claims.

The invention is based on a fossil-fueled power station, which has a steam turbine, the mean and low pressure stages of which comprise separate casings. The existing fossil-fueled power station is in this case to be retrofitted with a carbon dioxide separation apparatus.

In accordance with the invention, two steps are specified for this purpose. In the first step the maximum flow rate of the steam turbine is adjusted to the process steam to be removed for operation of the carbon dioxide separation device. In this way either the steam turbine path is adjusted by replacing components or parts of the low pressure state are replaced. The choice of options is determined by the existing steam turbine and the steam mass flows to be removed. In the second step, the carbon dioxide separation device is connected to the overflow line by way of a steam line. In the event of the carbon dioxide separation device switching off, the low pressure steam is also removed from the overflow line, routed via a bypass into an existing condenser and condensed therein. This is necessary since the retrofitted steam turbine can no longer be applied with the full steam quantity. The installation of a bypass line may in this way likewise be an integral part of the method.

In an advantageous further development, the carbon dioxide separation device is connected to the condenser of the steam turbine by way of a condensate regeneration line. The condensate regeneration line allows the process steam consumed in the desorption process to be fed back into the feed water circuit of the power station.

In an advantageous embodiment, the fossil-fueled power station is a gas and steam turbine power station, wherein the steam generator is a heat-recovery steam generator. Alternatively, the fossil-fueled power station is a steam turbine power station, wherein the steam generator is a fired boiler.

The adjustment of the maximum flow rate of the low pressure stage of the steam turbine allows the water/steam circuit to be optimized to the process steam removal for the carbon dioxide separation device. At the same time, the use of a bypass line ensures that the power station can continue to be operated in the event of the carbon dioxide separation apparatus failing and/or can be safely powered. Compromise solutions for the configuration before and after the changeover are no longer needed.

### BRIEF DESCRIPTION OF THE DRAWINGS

The invention is described in more detail below with the aid of drawings, in which;

FIG. 1 shows a fossil-fueled power station without a carbon dioxide separation device

FIG. 2 shows a fossil-fueled power station, which was retrofitted with a carbon dioxide separation device by means of the inventive method

### DETAILED DESCRIPTION OF INVENTION

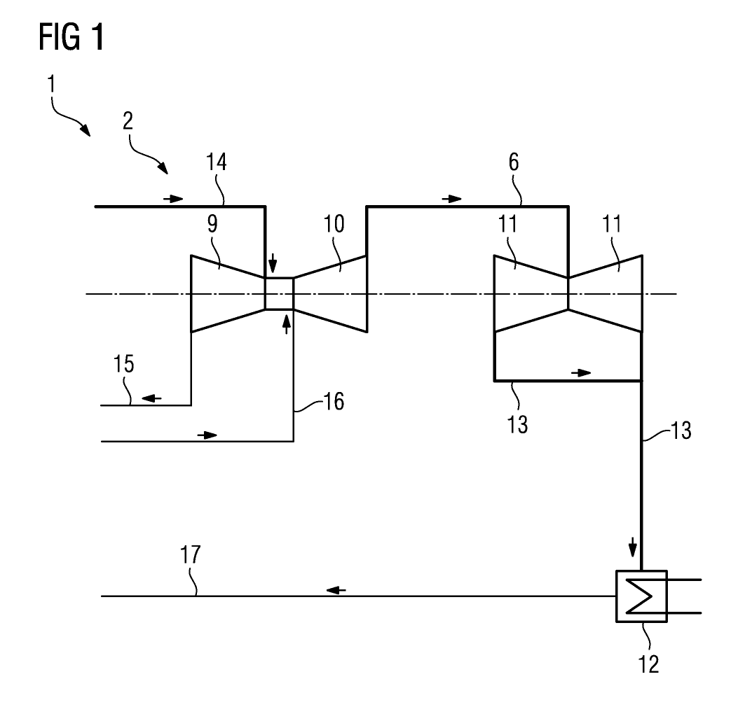

FIG. 1 shows a cutout of a fossil-fueled power station 1. The multiple casing steam turbine 2 is shown, which essentially consists of a high pressure stage 9, a mean pressure stage 10 and low pressure stage 11 arranged in a casing separated therefrom. In the variant shown here, the low pressure stage 11 is embodied in a multi-pass fashion. Furthermore, the condenser 12 is shown, which is connected to the low pressure stage 11 by way of a saturated steam line 13. The steam generator, which is a heat recovery steam generator in a gas and steam turbine system, and a fired boiler in a steam power plant, is not shown here in further detail.

The high pressure stage 9 is connected to a live steam line 14. In order to discharge a partially released steam, a cold intermediate superheating line 15 is connected to the high pressure stage 9, which connects the high pressure stage 9 to a steam generator (not shown in more detail here). The mean pressure stage 10 is connected to a hot intermediate superheating line 16 in a feed-like fashion, by way of which a further heated steam can be fed to the mean pressure stage. In order to discharge a partially released steam, the mean pressure stage 10 is connected to the low pressure stage 11 by way of an overflow line 6. The low pressure stage 14 is connected to the condenser 12 by way of the saturated steam line 13. The condensed steam can be fed back into the steam generator by way of a feed water line 17 which is connected to the condenser 12.

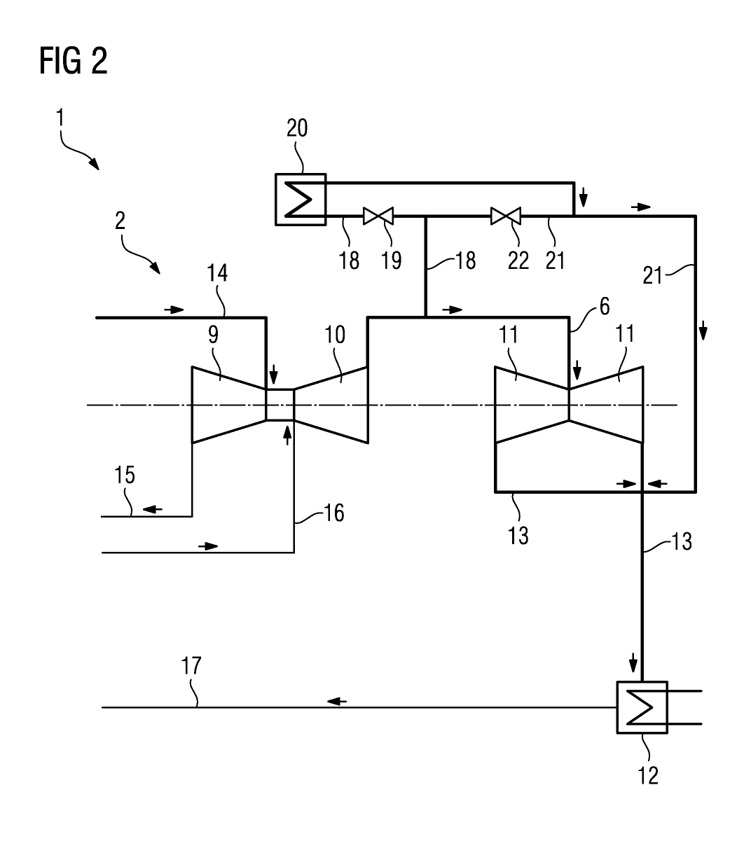

FIG. 2 shows, based on the arrangement shown in FIG. 1, a cutout of a fossil-fueled power station 1, which is retrofitted with a carbon dioxide separation apparatus according to the inventive method. The carbon dioxide separation device is shown here only in the form of a heat exchanger 20.

A process steam line 18 for removing a low pressure steam is connected to the overflow line 6. The low pressure stage 11 of the steam turbine 2 is also adjusted to the smaller steam quantities. A first valve 19 is connected in the process steam line 18. The process steam line 18 connects the overflow line 6 to the heat exchanger 20, which is an integral part of a desorber of the retrofitted carbon dioxide separation device. Low pressure steam for the heat exchanger 20 can be removed from the steam turbine process by way of the process steam line 18. To this end, the first valve 19 is opened.

In the event that the carbon dioxide separation device 3 is not in operation or has to be switched off, this first valve 19 is closed. The low pressure steam available through the process steam line 18 is now routed into the condenser 12. To this end, a bypass line 21 is provided, which connects the process steam line 18 to the saturated steam line 13. A second valve 22 which is connected in the bypass line 21 is opened for this purpose. Alternatively, the bypass line 21 can also be directly connected to the condenser 12 in order to discharge the low pressure steam.

1-5. (canceled)

6. A method for retrofitting a fossil-fueled power station including a multi-casing steam turbine with a carbon dioxide separation device, comprising:
adjusting the maximum flow rate of the steam turbine to the process steam to be removed for operation of the carbon dioxide separation device; and
connecting the carbon dioxide separation device to an overflow line connecting two steam turbine housings by way of a steam line.

7. The method as claimed in claim 6, wherein the carbon dioxide separation device is connected to a condenser of the steam turbine by way of a condensate regeneration line.

8. The method as claimed in claim 6,
wherein the fossil-fueled power station is a gas and steam turbine power station, and
wherein the steam generator is a heat-recovery steam generator.

9. The method as claimed in claim 6,
wherein the fossil-fueled power station is a steam turbine power station, and
wherein the steam generator is a fired boiler.

10. The method as claimed in claim 7,
wherein the fossil-fueled power station is a gas and steam turbine power station, and
wherein the steam generator is a heat-recovery steam generator.

11. The method as claimed in claim 7,
wherein the fossil-fueled power station is a steam turbine power station, and
wherein the steam generator is a fired boiler.
